(19) United States
(12) Patent Application Publication
(10) Pub. No.: US 2025/0299456 A1
(43) Pub. Date: Sep. 25, 2025

(54) METHOD AND SERVER FOR PROVIDING 3D IMAGE

(71) Applicant: SAMSUNG ELECTRONICS CO., LTD., Suwon-si (KR)

(72) Inventors: Younguk DO, Suwon-si (KR); Miyeon KIM, Suwon-si (KR); Gunhee LEE, Suwon-si (KR); Dohyun JO, Suwon-si (KR)

(73) Assignee: SAMSUNG ELECTRONICS CO., LTD., Suwon-si (KR)

(21) Appl. No.: 19/233,300

(22) Filed: Jun. 10, 2025

Related U.S. Application Data
(63) Continuation of application No. PCT/KR2023/018169, filed on Nov. 13, 2023.

(30) Foreign Application Priority Data
Dec. 14, 2022 (KR) 10-2022-0175304

(51) Int. Cl. G06T 19/20; G06T 17/00

(52) U.S. Cl. CPC G06T 19/20; G06T 17/00; G06T 2200/24; G06T 2210/04; G06T 2210/16; G06T 2219/2004

(57) ABSTRACT

A method for providing a three-dimensional (3D) image may include: receiving information associated with a product to which a fabric is to be applied from a user; receiving spatial information associated with a space where the product is to be placed; generating a 3D modeling image including the fabric applied to the product based on the spatial information and the information associated with the product; and displaying the 3D modeling image.

### CROSS-REFERENCE TO RELATED APPLICATION

This application is a continuation application is a continuation application, under 35 U.S.C. § 111 (a), of international application No. PCT/KR2023/018169, filed Nov. 13, 2023, which claims priority under 35 U. S. C. § 119 to Korean Patent Application No. 10-2022-0175304, filed Dec. 14, 2022, the disclosures of which are incorporated herein by reference in their entireties.

### TECHNICAL FIELD

The disclosure relates to a method and a server for providing a three-dimensional (3D) image that generates and provides the 3D image.

### BACKGROUND ART

Fabric products refer to interior and daily-life products made with fabric in people's living spaces, such as cushions, duvets, and curtains.

In order for a user to see a sample product made with fabric, an actual product had to be made with the corresponding fabric. In addition, an expert capable of operating software was required to provide a virtual graphic image of a fabric product using the software.

Accordingly, there is a growing demand for a method that may easily provide general users with fabric sample products in a virtual manner.

### DISCLOSURE

### Technical Problem

The disclosure provides a method for providing a three-dimensional (3D) image and a server that may provide a user with a desired fabric product design as a 3D image without directly producing the fabric product.

### Technical Solution

According to an aspect of the disclosure, a method for providing a three-dimensional (3D) image may include: receiving information associated with a product to which a fabric is to be applied from a user; receiving spatial information associated with a space where the product is to be placed; generating a 3D modeling image including the fabric applied to the product based on the spatial information and the information associated with the product; and displaying the 3D modeling image.

The method may further include calculating a recommended size of the product based on the spatial information, based on a size of the product not being included in the information associated with the product.

The information associated with the product may include a size of the product.

The method may further include determining a position where the product is to be placed in the space.

The determining of the position may include determining a recommended position of the product based on the spatial information.

The determining of the position may include determining based on a position of the product received from the user.

The information associated with the product may include at least one of a product type, a fabric type, a size, or a design of the product.

The spatial information may include information associated with at least one of a size of a wall in the space, a size of a window in the space, or a type and a size of other furniture placed in the space.

The method may further include changing a position where the product is to be placed in the space based on an input from the user, and generating and displaying a 3D image corresponding to information associated with the changed position.

According to an aspect of the disclosure, at least one server that performs a method for providing a three-dimensional (3D) image may include: a processor; and a memory configured to store at least one instruction executed by the processor, wherein the processor may be configured to: receive information associated with a product to which a fabric is to be applied from a user; receive spatial information associated with a space where the product is to be placed; generate a 3D modeling image including the fabric applied to the product based on the spatial information and the information associated with the product; and generate a control signal for displaying the 3D modeling image.

The processor may be configured to generate a control signal for calculating a recommended size of the product based on the spatial information, in response to a size of the product not being included in the information associated with the product.

The information associated with the product may include a size of the product.

The processor may be configured to generate a control signal for determining a position where the product is to be placed in the space.

The processor may be configured to generate a control signal for determining a recommended position of the product based on the spatial information.

The processor may be configured to generate a control signal for determining a position where the product is to be placed based on a position of the product received from the user.

The information associated with the product may include at least one of a product type, a fabric type, a size, or a design of the product.

The spatial information may include information associated with at least one of a size of a wall in the space, a size of a window in the space, or a type and a size of other furniture placed in the space.

The processor may be configured to generate a control signal for changing a position where the product is to be placed based on an input from the user, and generating and displaying a 3D image corresponding to information associated with the changed position.

### Advantageous Effects

According to an aspect of the disclosure, a user may be provided with a desired fabric product design as a 3D image without directly producing the fabric product.

In addition, a user may easily determine whether a fabric product is well-suited to environments such as furniture in the user's living space.

### DESCRIPTION OF DRAWINGS

FIG. 1 is a diagram illustrating an indoor space in which furniture and fabric products are located according to an embodiment.

FIG. 2 is a flowchart illustrating a method for providing a three-dimensional (3D) image according to an embodiment.

FIGS. 3, 4, 5 to FIG. 6 are diagrams illustrating spatial information and information about a fabric product that may be input by a user according to an embodiment.

FIG. 7 is a flowchart illustrating a process of calculating a size of a fabric product according to an embodiment.

FIG. 8 is a flowchart illustrating a process of determining a position where a fabric product is to be placed according to an embodiment.

FIGS. 9, 10, 11 to FIG. 12 are screens that provide a 3D modeling image based on user input according to an embodiment.

FIG. 13 is a control block diagram of a server providing a 3D image and a user terminal.

### MODES OF THE INVENTION

Embodiments described in the disclosure and configurations shown in the accompanying drawings are merely examples of the disclosure, and various modifications may replace the embodiments and the drawings of the disclosure at the time of filing of the application.

In addition, like reference numerals refer to like elements throughout the specification.

In addition, the terms used herein is for the purpose of describing particular embodiments only and is not intended to limit the disclosure. A singular form of a noun corresponding to an item may include one or more of the items unless clearly indicated otherwise in a related context. It will be understood that when the terms “includes”, “comprises”, “including”, and/or “comprising” are used in the disclosure, they specify the presence of the specified features, figures, steps, operations, components, members, or combinations thereof, but do not preclude the presence or addition of one or more other features, figures, steps, operations, components, members, or combinations thereof.

In addition, it is to be understood that when a certain component is referred to as being “connected to,” or “coupled with,” another component, it means that the component may be connected to or coupled with the other component directly or indirectly via a third component.

In addition, although the terms “first”, “second”, etc. may be used to describe various components, the terms do not limit the corresponding components, but are used only for the purpose of distinguishing one component from another. For example, without departing from the technical spirit or essential features of the disclosure, a first element may be referred to as a second element, and a second element may be referred to as a first element. As used herein, the term “and/or” includes any and all combinations of one or more of the associated listed items.

Hereinafter, an operating principle and embodiments of the disclosure will now be described with reference to accompanying drawings.

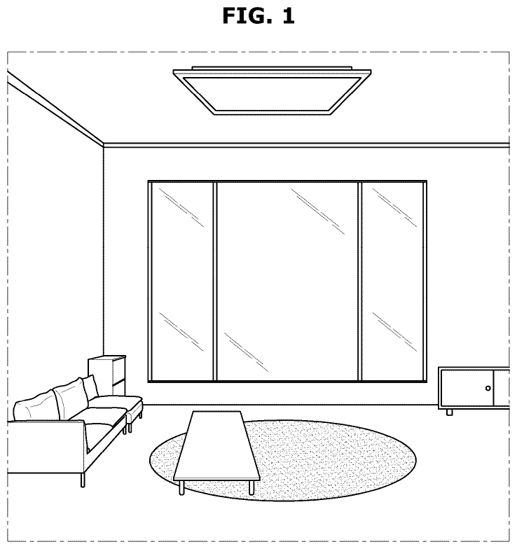

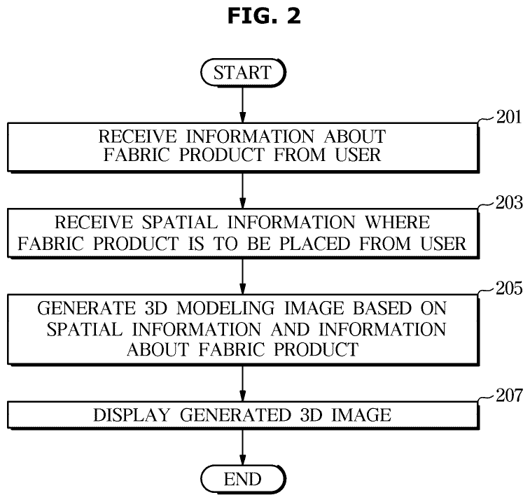

FIG. 1 is a diagram illustrating an indoor space where furniture and fabric products are located according to an embodiment. FIG. 2 is a flowchart illustrating a method for providing a three-dimensional (3D) image according to an embodiment.

Fabric products refer to interior and daily-life products made using fabric in people's living spaces, such as cushions, duvets, and curtains.

As shown in FIG. 1, a space may include a sofa, a table, a window, and the like. Various fabric products, such as a cushion placed on the sofa, a table runner placed on the table, and a curtain on the window, may be required in a living space.

In order for a user to see a sample product made with fabric, an actual product had to be made with the corresponding fabric. In addition, an expert capable of operating software was required to provide a virtual graphic image of a fabric product using the software.

In other words, when the user wanted a cushion, it was not easy for the user to intuitively know whether the cushion would match the sofa in the space, or whether the size of a curtain would be suitable for the size of the window.

Hereinafter, a method of providing an image in which a desired fabric product and the fabric product placed together with furniture are modeled in 3D to allow a user to view a sample fabric product is described in detail.

A user may input (enter) information about a fabric product (201), and may input spatial information about a space where the fabric product is to be placed (203).

The information about the fabric product may include information about at least one of a product type, a fabric type, a size, or a design of the fabric product. The spatial information may include information about the space where the fabric product is to be placed, i.e., a size of a wall in the space, a size of a window, and the like. In addition, the spatial information may include information about a type and a size of other furniture where the fabric product is to be placed in the space.

The information about the fabric product and the spatial information are described in detail below.

A 3D modeling image may be generated based on the information about the fabric product and the spatial information received from the user (205). Thereafter, the generated 3D modeling image may be displayed to allow the user to see the image (207).

The user may input various information to obtain the 3D modeling image of the fabric product. The information about the fabric product and spatial information that the user may input are described below.

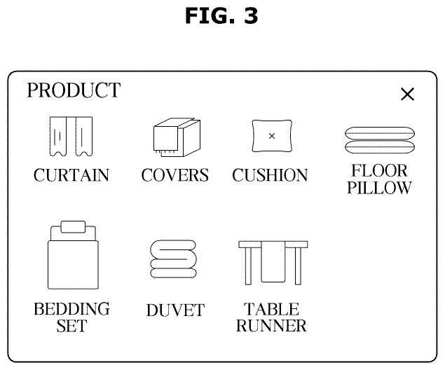

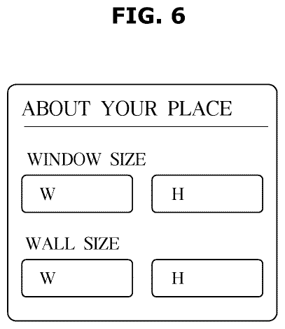

FIG. 3, 4, 5 to FIG. 6 are diagrams illustrating spatial information and information about a fabric product that may be input by a user.

Information about a fabric product may include information about a product type, a fabric type, a size, and a design of the fabric product.

The various fabric information may be predetermined and provided to a user.

That is, information about a product type, a fabric type, a size, and a design of at least one predetermined fabric product may be provided to the user.

For example, at least one predetermined fabric product, such as curtains, various covers, cushions, floor pillows, pillows, duvets, and table runners, may be provided to the user in the form of a list or the like, and the user may select a desired fabric product from the list.

That is, information about a product type, a fabric type, a size, and a design of the fabric product selected by the user may be received.

The listed fabric product information is only an example, and the user may input various other information related to the fabric product in addition to the listed information.

Referring to FIG. 3, the user may select a desired fabric product type as needed.

A fabric product is a product that may be made with fabric, such as curtains, various covers, cushions, floor pillows, pillows, duvets, and table runners.

The products listed in FIG. 3 are merely examples of products that may be made as a fabric product, and many different products made with fabric may also be included.

In a case where the user wishes to view an image of curtain, the user may select a curtain from among a plurality of products, and thus receive various 3D images of curtains.

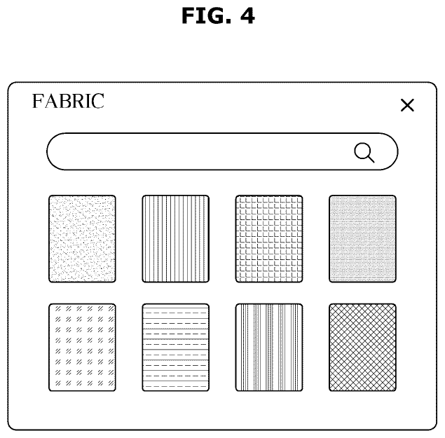

Referring to FIG. 4, the user may select the type of fabric.

Fabrics may include a variety of fabric types, and the user may select a fabric according to personal preference or need. That is, the user may select one from images of at least one predetermined fabric.

A 3D modeling image of the fabric product to which the selected fabric is applied may be generated according to the user input that selects the fabric.

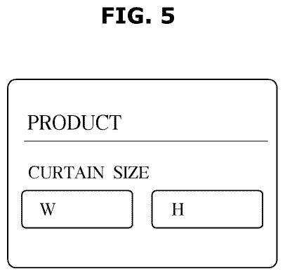

The user may not only select a predetermined fabric image, but also input information about a fabric by directly photographing the fabric or uploading a previously generated fabric image. Referring to FIG. 5, the user may select a size of the fabric product.

In a case where the user selected a curtain as a fabric product in FIG. 3, the user may input the size of the curtain via an interface provided for inputting the curtain size.

Although FIG. 5 illustrates an example of entering the curtain size, the user may input the size of various fabric products, depending on the selected fabric product.

For example, in a case where the user selected a cushion as a fabric product, user input for the size of the cushion may be received.

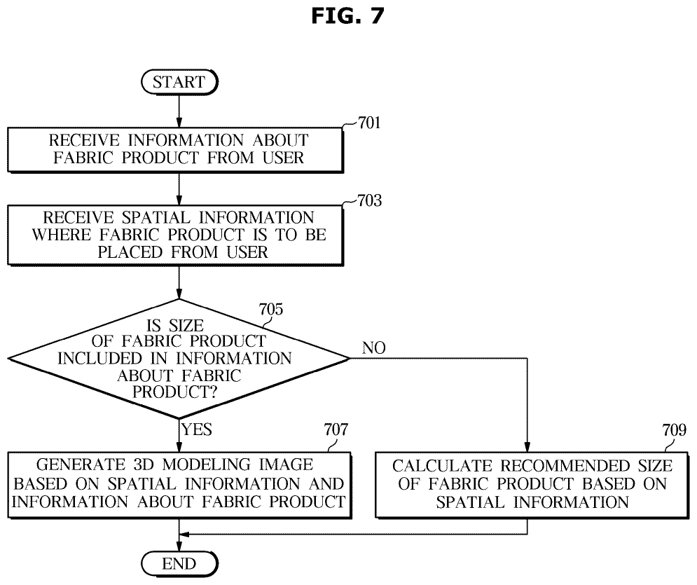

Regarding the reception of the size of the fabric product, without the user inputting the size of the fabric product, a recommended size of the fabric product may be calculated and provided to the user based on the spatial information, which is described in FIG. 7.

The spatial information may include information about a size of a wall in the space, a size of a window in the space, and a type and a size of other furniture in the space.

Specifically, the spatial information may include various types of information depending on the fabric product selected by the user.

For example, FIG. 6 illustrates an input interface screen for spatial information in a case where the user selected a curtain as a fabric product.

That is, in a case where the user selected a curtain as a fabric product, information about the space where the curtain is to be installed, i.e., the size of the wall and the size of the window on which the curtain is to be installed, may be received from the user.

As described above, regarding the reception of the size of the fabric product among the information about the fabric product, in addition to the user directly entering the size of the fabric product, a recommended size of the fabric product may be calculated and provided to the user based on the spatial information received from the user.

FIG. 7 is a flowchart illustrating a process of calculating a size of a fabric product according to an embodiment.

As described above, information about a fabric product and spatial information about a space where the fabric product is to be placed may be received from a user (701, 703).

The information about the fabric product received from the user may include a size of the fabric product.

In a case where the information about the fabric product includes the size of the fabric product (Yes in operation 705), a 3D modeling image may be generated based on the information about the fabric product and the spatial information received from the user (707).

That is, as shown in FIG. 5, in a case where information about the size of the curtain is received from the user, a 3D modeling image may be generated based on the curtain size information and the size information of the wall and window received from the user.

On the other hand, the size of the fabric product may not be included in the information about the fabric product received from the user.

In a case where the information about the fabric product does not include the size of the fabric product (NO in operation 705), a recommended size of the fabric product may be calculated based on the spatial information received from the user (709).

For example, in a case where the user selected a cushion as a fabric product but did not input the cushion size, a recommended size of the cushion may be calculated based on the spatial information input by the user.

In a case where the user selected a cushion as a fabric product, size information of a sofa may be received as the spatial information where the fabric product is to be placed.

Accordingly, the recommended size of the cushion may be calculated based on the sofa size information received from the user, and a 3D modeling image of the cushion may be generated based on the calculated size information.

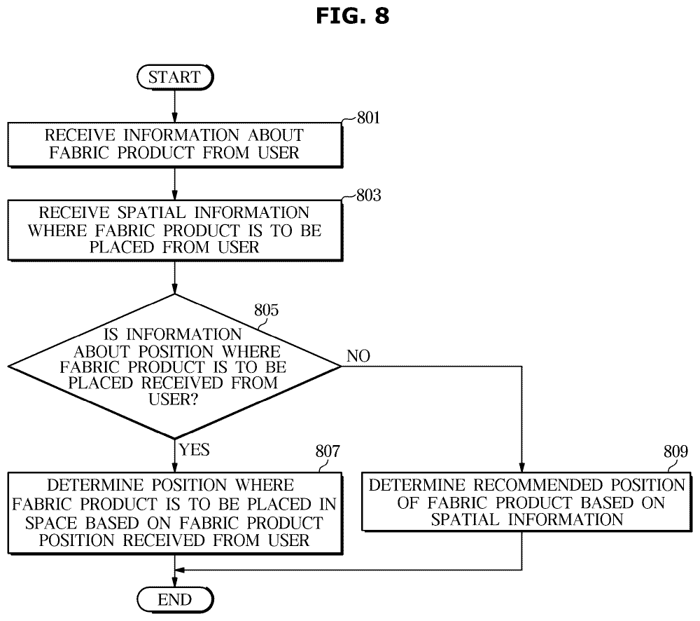

FIG. 8 is a flowchart illustrating a process of determining a position where a fabric product is to be placed according to an embodiment.

In providing a 3D modeling image to a user, an operation of determining a position where a fabric product is to be placed within a space may be further included.

As described above, information about the fabric product and spatial information about the space where the fabric product is to be placed may be received from the user (801, 803).

The user may further input information about a position where the fabric product is to be placed.

In a case where the information about the position where the fabric product is to be placed is received from the user (Yes in operation 805), the position where the fabric product is to be placed in the space may be determined based on the position information for the fabric product received from the user (807). Thereafter, a 3D modeling image reflecting the determined position may be generated.

In a case where the information about the position where the fabric product is to be placed is not received from the user (No in operation 805), a recommended position of the fabric product may be determined based on the spatial information received from the user (809).

For example, in a case where the user selected a pillow or a duvet as a fabric product, but did not input position information where the pillow or the duvet is to be placed, a recommended position for placing the pillow or the duvet may be determined based on the spatial information input by the user.

That is, in a case where the user selected a pillow or a duvet as a fabric product, an appropriate position on the bed, on which the fabric product is to be placed, may be determined, and a 3D modeling image may then be generated based on the determined information.

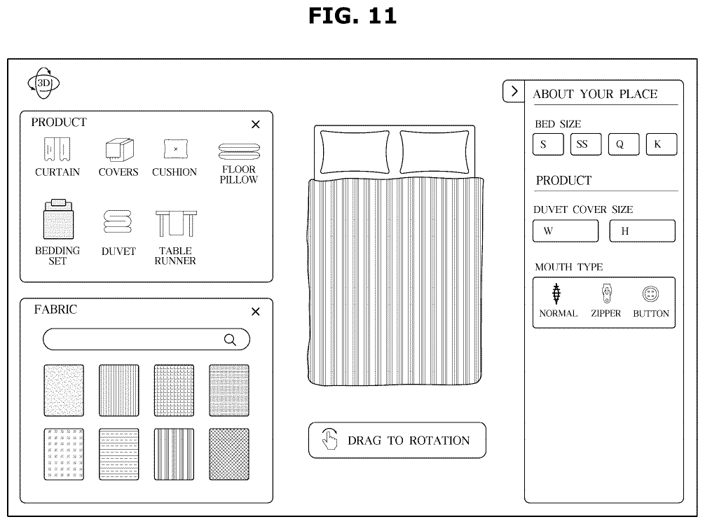

As shown in FIG. 11, in a case where the user selected a pillow and a duvet as a fabric products, an appropriate position on the bed where the fabric products are placed may be determined, and a 3D modeling image where the pillow and the duvet are placed on the bed may be generated.

Hereinafter, providing a 3D modeling image through a screen for the 3D modeling image is described in detail.

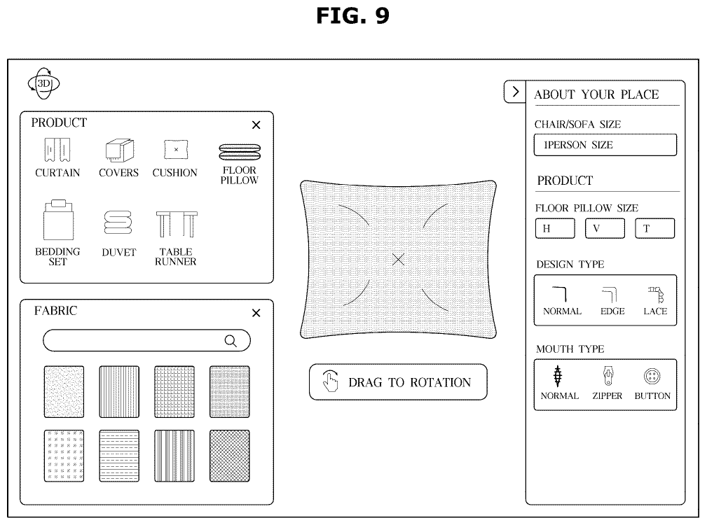

FIG. 9 to FIG. 12 are screens that provide a 3D modeling image based on user input.

FIG. 9 shows a screen providing a 3D modeling image in a case where a user selected a floor pillow as a fabric product.

The user may select the floor pillow as a fabric product, and may select a fabric type of the fabric product.

The product types and the fabric types shown in the drawing are merely examples, and various other types of fabric products and fabric types may be included.

Because the user selected the floor pillow, the user may input spatial information about a space where the floor pillow is to be placed, i.e., spatial information about a chair or sofa.

As shown in FIG. 9, in a case where the user enters a size of the chair or sofa as a single-person size without entering information about a size of the floor pillow, a recommended size of the floor pillow may be calculated based on the size information of the chair or sofa.

In other words, an appropriate floor pillow size for a single-person chair or sofa may be calculated.

In a case where the user inputs information about the size of the floor pillow, the floor pillow size may be determined based on the input information, without calculating the recommended size of the floor pillow as described above.

In addition, the user may input information about a design of the floor pillow.

As shown in FIG. 9, the user may select a desired design from among a normal type, an edge type, and a lace type.

The types of designs for the fabric product shown in the drawing are merely examples, and various other types of fabric product designs may be included.

As the user inputs information about the fabric product and spatial information, a 3D modeling image may be generated based on the spatial information and the information about the fabric product received from the user, and the generated 3D modeling image may be displayed to allow the user to view the image.

Although FIG. 9 shows only the floor pillow as the 3D modeling image, depending on the spatial information input by the user, the floor pillow placed on the chair or sofa may be modeled in 3D and displayed together.

The user may change the position where the fabric product is to be placed, and a 3D image corresponding to the changed position information may be generated and displayed.

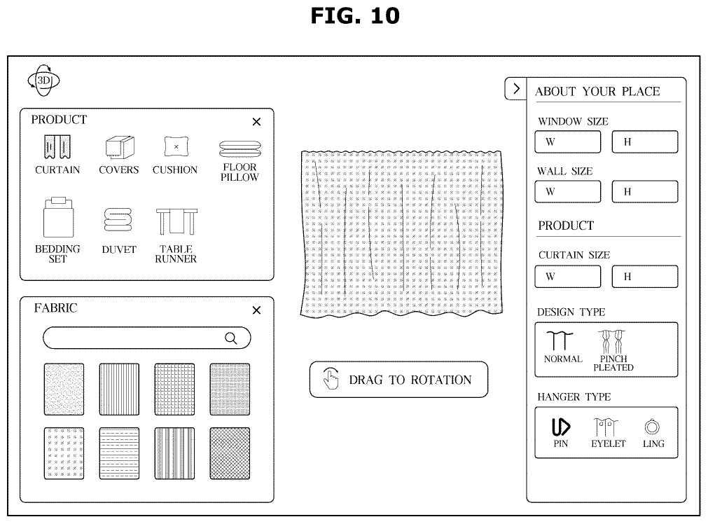

FIG. 10 shows a screen providing a 3D modeling image in a case where a user selected a curtain as a fabric product.

A user may select a curtain as a fabric product, and may select a fabric type of the fabric product.

The product types and the fabric types shown in the drawing are merely examples, and various other types of fabric products and fabric types may be included.

Because the user selected the curtain, the user may input spatial information about a space where the curtain is to be placed, i.e., information about a wall and a window.

In a case where the user enters information about a size of the wall and the window as the spatial information without entering information about a size of the curtain, a recommended size of the curtain may be calculated based on the wall and window size information.

In a case where the user enters information about the size of the curtain, the curtain size may be determined based on the input information, without calculating the recommended size of the curtain as described above.

In addition, the user may input information about a design of the curtain.

As shown in FIG. 10, the user may select a desired design from among a normal type and a pinch type. The types of designs for the fabric product shown in the drawing are merely examples, and various other types of fabric product designs may be included.

As the user inputs information about the fabric product and spatial information, a 3D modeling image may be generated based on the spatial information and the information about the fabric product received from the user, and the generated 3D modeling image may be displayed to allow the user to view the image.

Although FIG. 10 shows only the curtain as the 3D modeling image, depending on the spatial information input by the user, the curtain arranged on the wall may be modeled in 3D and displayed together.

The user may change the position where the fabric product is to be placed, and a 3D image corresponding to the changed position information may be generated and displayed.

FIG. 11 shows a screen providing a 3D modeling image in a case where a user selected a duvet as a fabric product.

The user may select the duvet as a fabric product, and may select a fabric type of the fabric product.

The product types and the fabric types shown in the drawing are merely examples, and various other types of fabric products and fabric types may be included.

Because the user selected the duvet, the user may input spatial information about a space where the duvet is to be placed, i.e., information about a bed.

In a case where the user enters a size of the bed as the spatial information without entering information about a size of the duvet, a recommended size of the duvet may be calculated based on the input bed size information.

That is, in a case where the user enters the size of the bed as queen size Q, an appropriate duvet size for a queen-size bed may be calculated.

In a case where the user enters information about the size of the duvet, the duvet size may be determined based on the input information, without calculating the recommended size of the duvet as described above.

In addition, the user may input information about a design of the duvet.

As the user inputs information about the fabric product and spatial information, a 3D modeling image may be generated based on the spatial information and the information about the fabric product received from the user, and the generated 3D modeling image may be displayed to allow the user to view the image.

Although FIG. 11 shows the 3D modeling image of the duvet together with the pillow on the bed, only the duvet may be modeled in 3D and displayed.

The user may change the position where the fabric product is to be placed, and a 3D image corresponding to the changed position information may be generated and displayed.

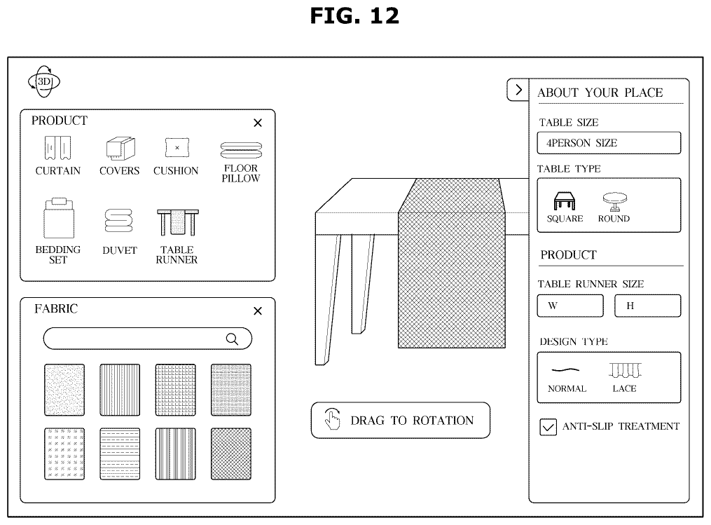

FIG. 12 shows a screen providing a 3D modeling image in a case where a user selected a table runner as a fabric product.

The user may select the table runner as a fabric product, and may select a fabric type of the fabric product.

The product types and the fabric types shown in the drawing are merely examples, and various other types of fabric products and fabric types may be included.

Because the user selected the table runner, the user may input spatial information about a space on which the table runner is to be placed, i.e., information about a table.

In a case where the user enters a size of the table as the spatial information without entering information about a size of the table runner, a recommended size of the table runner may be calculated based on the input table size information.

As shown in FIG. 12, in a case where the user enters the size of the table as a four-person size without entering information about the size of the table runner, a recommended size of the table runner may be calculated based on the table size information.

That is, an appropriate size of the table runner for a four-person size table may be calculated.

In addition, the user may input a type of the table as the spatial information.

As shown in FIG. 12, an appropriate size and shape of the table runner may be calculated based on user's selection of a square type or a round type.

In a case where the user enters information about the size of the table runner, the table runner size may be determined based on the input information, without calculating the recommended size of the table runner as described above.

In addition, the user may input information about a design of the table runner.

As shown in FIG. 12, the user may select a desired design from among a normal type and a lace type. The types of designs for the fabric product shown in the drawing are merely examples, and various other types of fabric product designs may be included.

As the user inputs information about the fabric product and spatial information, a 3D modeling image may be generated based on the spatial information and the information about the fabric product received from the user, and the generated 3D modeling image may be displayed to allow the user to view the image.

Although FIG. 12 shows the 3D modeling image of the table runner together with the table, only the table runner may be modeled in 3D and displayed.

The user may change the position where the fabric product is to be placed, and a 3D image corresponding to the changed position information may be generated and displayed.

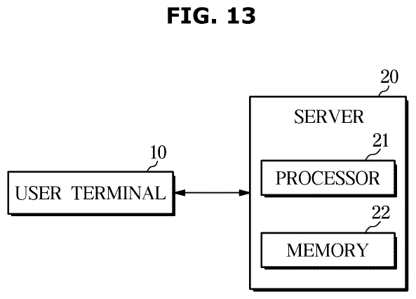

FIG. 13 is a control block diagram of a server providing a 3D image and a user terminal.

The above-described method for providing a 3D image may be performed by at least one server 20.

The server 20 may include a processor 21 and a memory 22, and user input may be performed by a user terminal 10.

The processor 21 may refer to a central processing unit (CPU), a graphics processing unit (GPU), or a dedicated processor for performing the method according to embodiments of the disclosure. The memory 22 may be configured as at least one of a volatile storage medium or a non-volatile storage medium. For example, the memory 22 may be one of read only memory (ROM) and random access memory (RAM).

The user terminal 10 may include a communicable desktop computer, laptop computer, smart phone, tablet PC, mobile phone, smart watch, smart glass, e-book reader, portable multimedia player (PMP), handheld game console, navigation device, digital camera, digital multimedia broadcasting (DMB) player, digital audio recorder, digital audio player, digital video recorder, digital video player, personal digital assistant (PDA), or the like.

The processor 21 may receive information about a fabric product from a user through the user terminal 10, receive spatial information about a space where the fabric product is to be placed from the user, generate a 3D modeling image based on the spatial information and the information about the fabric product, and generate a control signal for displaying the 3D modeling image.

In addition, a program for executing the above-described method for providing a 3D image may also be implemented in the form of a recording medium.

According to an aspect of the disclosure, a user may be provided with a desired fabric product design as a 3D image without directly producing the fabric product.

In addition, a user may easily determine whether a fabric product is well-suited to environments such as furniture in the user's living space.

Meanwhile, the disclosed embodiments may be implemented in the form of a recording medium that stores instructions executable by a computer. The instructions may be stored in the form of program codes, and when executed by a processor, the instructions may create a program module to perform operations of the disclosed embodiments. The recording medium may be implemented as a computer-readable recording medium.

The computer-readable recording medium may include all kinds of recording media storing instructions that may be interpreted by a computer. For example, the computer-readable recording medium may be a read only memory (ROM), a random access memory (RAM), a magnetic tape, a magnetic disk, a flash memory, an optical data storage device, etc.

Although embodiments of the disclosure have been described with reference to the accompanying drawings, a person having ordinary skilled in the art will appreciate that other specific modifications may be easily made without departing from the technical spirit or essential features of the disclosure. Accordingly, the foregoing embodiments should be regarded as illustrative rather than limiting in all aspects.

1. A method for providing a three-dimensional (3D) image, the method comprising:
receiving information associated with a product to which a fabric is to be applied from a user;
receiving spatial information associated with a space where the product is to be placed;
generating a 3D modeling image including the fabric applied to the product based on the spatial information and the information associated with the product; and
displaying the 3D modeling image.

2. The method of claim 1, wherein the receiving of the information associated with the product comprises receiving information associated with a product type, a fabric type, a size, and a design involving the product selected by the user from among information associated with a product type, a fabric type, a size, and a design involving at least one preset product.

3. The method of claim 1, wherein the receiving of the information associated with the product comprises receiving an image of the fabric to be applied to the product from the user, or receiving an image in which the fabric is selected by the user from at least one preset fabric image.

4. The method of claim 1, further comprising:
calculating a recommended size of the product based on the spatial information, based on a size of the product not being included in the information associated with the product.

5. The method of claim 1, wherein the information associated with the product includes a size of the product.

6. The method of claim 1, further comprising:
determining a position where the product is to be placed in the space.

7. The method of claim 6, wherein the determining of the position comprises determining a recommended position of the product based on the spatial information.

8. The method of claim 6, wherein the determining of the position comprises determining based on a selected position of the product received from the user.

9. The method of claim 1, wherein the information associated with the product includes at least one of a product type, a fabric type, a size, or a design of the product.

10. The method of claim 1, wherein the spatial information includes information associated with at least one of a size of a wall in the space, a size of a window in the space, or a type and a size of other furniture placed in the space.

11. The method of claim 1, further comprising:
changing a position where the product is to be placed in the space based on an input from the user, and generating and displaying a 3D image corresponding to information associated with the changed position.

12. At least one server that performs a method for providing a three-dimensional (3D) image, the at least one server comprising:
a processor; and
a memory configured to store at least one instruction executed by the processor,
wherein the processor is configured to:
receive information associated with a product including a fabric to be applied to the product from a user;
receive spatial information associated with a space where the product is to be placed;
generate a 3D modeling image including the fabric applied to the product based on the spatial information and the information associated with the product; and
generate a control signal for displaying the 3D modeling image.

13. The at least one server of claim 12, wherein the processor is configured to receive information associated with a product type, a fabric type, a size, and a design of a product selected by the user from among information associated with a product type, a fabric type, a size, and a design of at least one preset product.

14. The at least one server of claim 12, wherein the processor is configured to receive an image of the fabric from the user, or receive an image in which the fabric is selected by the user from at least one preset fabric image.

15. The at least one server of claim 12, wherein the processor is configured to generate a control signal for calculating a recommended size of the product based on the spatial information, in response to a size of the product not being included in the information associated with the product.
